(19) United States
(12) Patent Application Publication
(10) Pub. No.: US 2026/0185818 A1
(43) Pub. Date: Jul. 2, 2026

(54) MEASUREMENT DEVICE

(71) Applicant: QUJING EVE ENERGY CO., LTD., Qujing (CN)

(72) Inventors: Shilin KUAI, Qujing (CN); Pengchong DING, Qujing (CN); Wenjun WU, Qujing (CN); Heng LI, Qujing (CN); Jincheng LIU, Qujing (CN)

(73) Assignee: QUJING EVE ENERGY CO., LTD.,, Qujing (CN)

(21) Appl. No.: 19/336,423

(22) Filed: Sep. 22, 2025

Related U.S. Application Data
(63) Continuation of application No. PCT/CN2025/089243, filed on Apr. 16, 2025.

(30) Foreign Application Priority Data
Dec. 31, 2024 (CN) 202423307406.2

(51) Int. Cl. G01B 11/02; H01M 4/76

(52) U.S. Cl. CPC G01B 11/028; H01M 4/765

(57) ABSTRACT

A measurement device for measuring a length of an insulating tape exposed at an end portion of a winding core is provided, including: a body and at least one measurement structure provided on the body, where the measurement structure includes a positioning member inserted into a central hole of the winding core, and a length measuring member for measuring an exposed length of the insulating tape with respect to the winding core.

### CROSS REFERENCE TO RELATED APPLICATION

This application is a continuation of an International Application No. PCT/CN 2025/089243, filed on Apr. 16, 2025, which claims priority to Chinese Patent Application No. 202423307406.2, entitled “MEASUREMENT DEVICE”, filed on Dec. 31, 2024, the disclosures of which are incorporated herein by reference in their entireties.

### TECHNICAL FIELD

The present disclosure relates to the field of battery technologies, and more particular to a measurement device.

### BACKGROUND

In a process for manufacturing a lithium battery, in order to avoid a contact between positive and negative electrode sheets and an aluminum case, after winding of a core is completed, an insulating tape is applied to the periphery of the winding core to separate a tab from the aluminum case by the insulating tape. Therefore, the consistency of an exposed length of the tape with respect to the winding core is related to the quality and safety of the core.

In the related art, a Charge-Coupled Device (CCD) measurement or an optical lens instrument measurement is generally used to measure the exposed length of the tape.

### SUMMARY

In a first aspect, the present disclosure provides a measurement device for measuring a length of an insulating tape exposed at an end portion of a winding core, including: a body and at least one measurement structure provided on the body, where the measurement structure includes a positioning member inserted into a central hole of the winding core, and a length measuring member for measuring an exposed length of the insulating tape with respect to the winding core.

### BRIEF DESCRIPTION OF THE DRAWINGS

FIG. 1 is a perspective diagram of a winding core according to some embodiments of the present disclosure.

FIG. 2 is a schematic structural diagram of the winding core of FIG. 1.

FIG. 3 is a schematic structural diagram of a measurement device from one perspective according to some embodiments of the present disclosure.

FIG. 4 is a schematic structural diagram of a measurement device from another perspective according to some embodiments of the present disclosure.

FIG. 5 is a first use state reference diagram of the measurement device of FIG. 3.

FIG. 6 is a second use state reference diagram of the measurement device of FIG. 3.

FIG. 7 is an enlarged view of a portion I in FIG. 5.

FIG. 8 is a third use state reference diagram of the measurement device of FIG. 3.

FIG. 9 is a fourth use state reference diagram of the measurement device of FIG. 3.

FIG. 10 is an enlarged view of a portion II in FIG. 9.

FIG. 11 is a schematic flow diagram of a measurement method according to some embodiments of the present disclosure.

### DETAILED DESCRIPTION

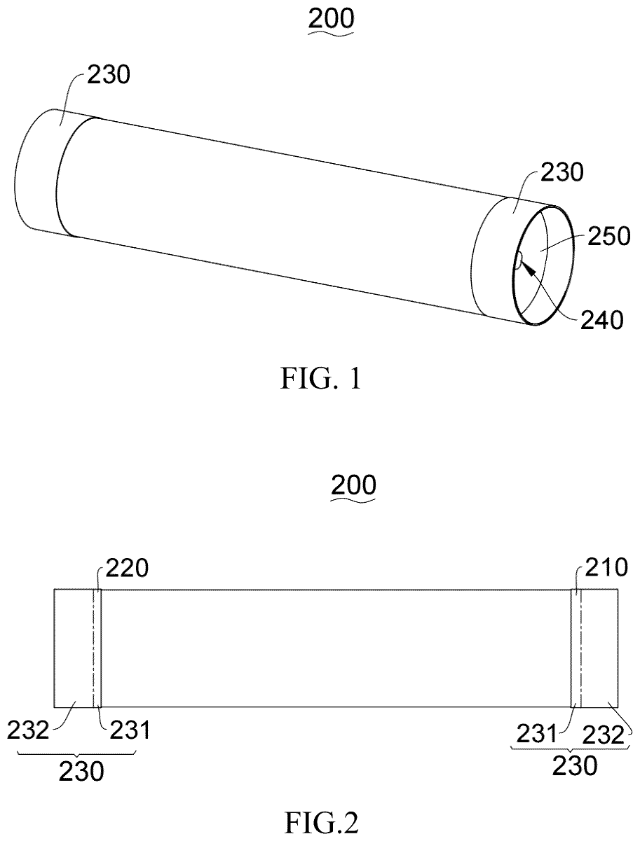

Referring to FIGS. 1 and 2, the winding core 200 may be formed with a hole 240 in the center of the winding core after the winding of the winding core is completed, and an insulating tape 230 is wound around each of the two end portions of the winding core 200 so as to respectively separate a positive tab 220 and a negative tab 210 from a case to avoid a short circuit. In some embodiments, after the winding of the insulating tape 230 is completed, a portion of the insulating tape 230 is raised above an end surface 250 of the winding core 200, i.e., as an exposed portion, and another portion of the insulating tape 230 covers the positive tab 220 or the negative tab 210.

In some embodiments, referring to FIG. 2, the insulating tape includes two segments in an axial direction of the winding core 200, i.e., a first segment 231 and a second segment 232, where the first segment 231 is wrapped around the outside of the winding core 200 to cover the positive tab 220 or the negative tab 210, the second segment 232 is exposed relative to the end surface 250 of the winding core 200, the exposed second segment 232 is subsequently flattened toward the end surface 250 of the winding core 200, and the positive and negative tabs 210 are respectively welded to a current collecting plate.

In the production process, when the length of the insulating tape 230 is not controlled properly, if the exposed length is too long, the current collecting plate is in poor contact with the positive and negative tabs 210, and if the exposed length is too short, the tabs cannot be covered, so that the product quality is affected. Therefore, it is necessary to measure the length of the exposed second segment 232 of the insulating tape 230. However, in the related art, neither the CCD measurement nor the optical lens instrument measurement can be used to obtain the length quickly, thereby affecting the production capacity.

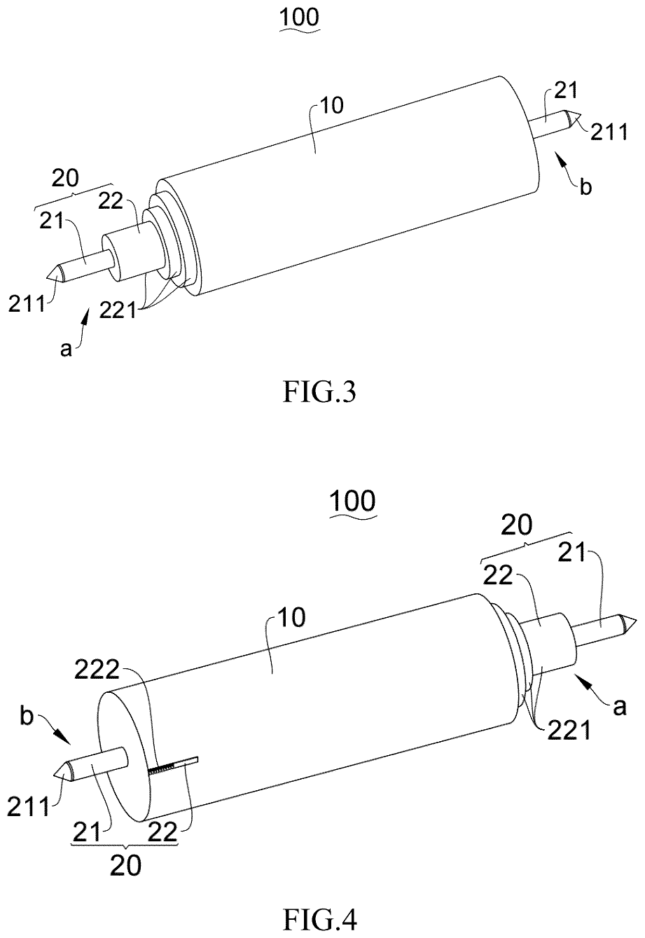

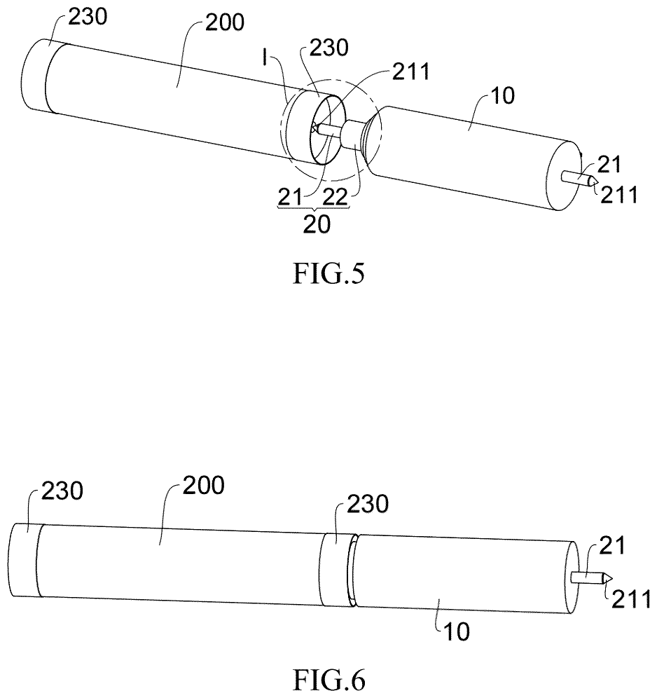

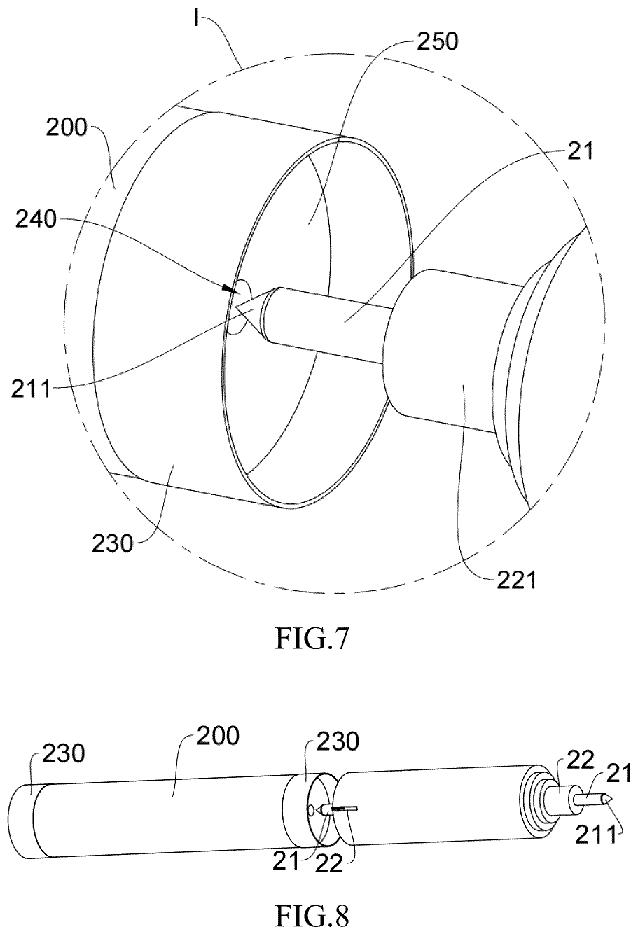

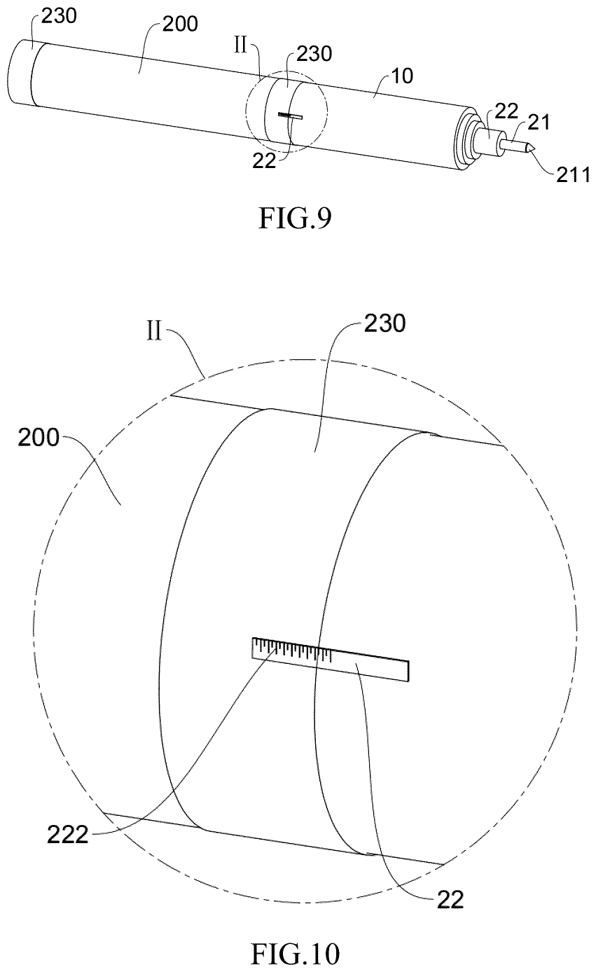

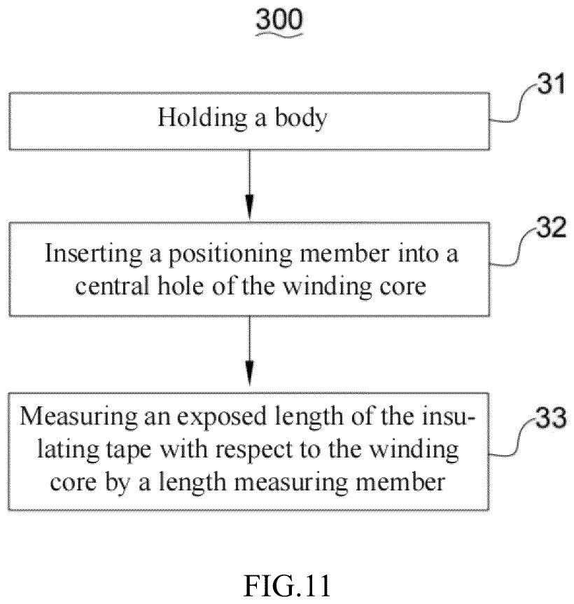

Therefore, in order to enable rapid measurement of the exposed length of the insulating tape 230, referring to FIGS. 3 to 10, a measurement device 100 according to some embodiments of the present disclosure includes a body 10 and at least one measurement structure 20 provided on the body 10.

In some embodiments, referring to FIGS. 3 and 4, the measurement structure 20 includes a positioning member 21 inserted into a central hole 240 of the winding core 200 and a length measuring member 22 for measuring an exposed length of the insulating tape 230 relative to the winding core 200.

According to the measurement device 100, by inserting the positioning member 21 into the central hole 240 of the winding core 200, the exposed length of the insulating tape 230 can be quickly obtained by the length measuring member 22, so that the measuring efficiency is improved. At the same time, the winding core 200 can be conveyed one by one on a conveying belt during the measurement, and the production line does not need to be suspended, thereby ensuring the production capacity.

In some embodiments, when the winding core 200 is measured, a plurality of successively juxtaposed positioning tools may be placed on the conveying belt and each used to place the winding core 200 for positioning, so that the winding core 200 can be conveyed one by one by the conveying belt. A worker holds the measurement device 100 by hand and inserts the positioning member 21 of the measurement device 100 into the hole 240 of the winding core 200, that is, the measurement of the exposed length of the insulating tape 230 can be quickly achieved by the length measuring member 22, and then the winding core 200 is put back into the positioning tool after the measurement, and the worker can measure the exposed length of the insulating tape 230 on a workstation without carrying the winding core 200 to a special laboratory, and the production line does not need to be suspended, so that the production efficiency is higher, the production capacity is improved, and a result of the measurement can be quickly and accurately obtained by the length measuring member 22.

In some embodiments, in a process of the measurement, the worker's hand slowly pushes the positioning member 21 into the hole 240 of the winding core 200, so that the positioning member 21 completely enters the hole 240, and then the winding core 200 and the measurement device 100 are placed on a horizontal plane, and the eye looks down to quickly obtain a corresponding result of the exposed length of the insulating tape 230 according to the length measuring member 22.

In some embodiments, the body is cylindrical, and in some embodiments, may also be provided in a square, diamond, triangular, polygonal, or the like structure, which is not limited herein.

Referring to the drawings, in some embodiments, in order to provide different measurement modes, the measurement device 100 includes two measurement structures 20, where the two measurement structures 20 are defined as first and second measurement structures a and b, respectively, the first and second measurement structures a and b are provided at both ends of the body 10, respectively, along the length direction of the body 10, a first length measuring member in the first measurement structure a is used to perform a coarse measurement of the exposed length of the insulating tape 230 with respect to the winding core 200, and a second length measuring member in the second measurement structure b is used to perform a fine measurement of the exposed length of the insulating tape 230 with respect to the winding core 200, that is, the length measuring members 22 in the two measurement structures 20 may be provided in different structures to achieve a result of a rapid coarse measurement or a fine measurement, so as to meet the requirements of the production of the different winding cores 200.

In some embodiments, when a first type of winding cores 200 are always in the production line, the exposed lengths of the insulating tapes 230 of the same type of the winding cores 200 are substantially the same, only a fine difference can be made. For example, when a difference between the exposed lengths of the insulating tape 230 and a standard value of the lengths is in a range of ±(0.5-1 mm), the production requirements can be satisfied. Therefore, the production efficiency can be improved by performing the rapid measurement by the first length measuring member. However, when the production line is replaced, since the type of the winding cores 200 is replaced, the exposed length of the insulating tape 230 differs greatly in this case, and it is necessary to accurately measure the exposed length of the insulating tape 230 by the second length measuring member to determine whether the measured exposed length is within a predetermined error range.

In some embodiments, referring to FIG. 3 and FIGS. 7 to 9, the first length measuring member is provided on the first positioning member 21 and includes a plurality of positioning platforms 221 joined in sequence in the axial direction of the body 10. The plurality of positioning platforms 221 have different widths in a radial direction of the body 10, that is, each of the positioning platforms 221 has its own width. When the first positioning member 21 is inserted into the hole 240 of the winding core 200, the end surface of the insulating tape 230 is positioned corresponding to a certain one of positioning platforms 221, so that the exposed length of the insulating tape 230 can be quickly judged. For example, if the end surface of the insulating tape 230 is positioned corresponding to a preset positioning platform, the qualification of the winding core 200 can be quickly judged. That is, in a case that the positioning platforms 221 are provided with different widths, when the insulating tape 230 can be aligned with corresponding one of the positioning platforms 221, a quick judgment can be made to improve the test efficiency. In some embodiments, when the positioning platforms 221 are provided with different widths, corresponding center angles of the positioning platforms 221 may be less than 360 degrees, for example, 30 degrees, 45 degrees, or 60 degrees. In a length direction of the body 10, the plurality of positioning platforms 221 may be provided in such a manner that the positioning platforms 221 are sequentially staggered in the axial direction of the first positioning member 21, and the efficiency of the judgment may also be improved.

It should be understood that the more the number of positioning platforms 221 is provided, the smaller the height of each of the positioning platforms 221 in the length direction of the body 10, and the accuracy of the judgment can be improved.

In some embodiments, when a plurality of positioning platforms 221 are provided in the length direction of the body 10, the widths of the plurality of positioning platforms 221 in the radial direction of the body 10 may be provided in a gradually increasing manner towards a direction closer to the body 10. That is, the closer the positioning platforms 221 are disposed towards the body 10, the larger the widths of the positioning platforms 221 in the radial direction of the positioning member 21 is, and the width of the positioning platform can be gradually closer to the width of the body 10, so that the widths of the positioning platforms 221 are provided in a regular manner, thereby facilitating the molding of the plurality of positioning platforms 221 and the body 10.

In some embodiments, each of the positioning platforms 221 has a cylindrical shape, that is, the positioning member 21 is surrounded by 360 degrees outside the positioning member 21 be means of the positioning platforms 221, so that the structural strength of the positioning member 21 can be improved.

In some embodiments, in order to improve the judgment efficiency in a process of the measurement, the surface of each of the positioning platforms 221 is coated with a coating, and the color of the coating on the surface of the each of the positioning platforms 221 is different from each other. As such, by applying a color to the positioning platforms 221, the color can bring a visual impact sense to the eye, so that it is possible to roughly judge whether the length of the insulating tape 230 meets a predetermined standard range according to the color of the positioning platform corresponding to the insulating tape 230, thereby improving the measurement efficiency. In some embodiments, when three positioning platforms 221 are provided, the positioning platforms 221 may be sequentially coated with yellow, green, and red in a direction gradually closer to the body 10. It should be noted that the colors of the positioning platforms 221 may be set as required, which not limited herein.

In some embodiments, the measurement structure 20 and the body 10 are integrally provided, that is, the positioning platforms 221, the positioning member 21, and the body 10, when provided, can be molded in an integrated manner to improve molding efficiency and ensure structural strength of the measurement device. In some embodiments, the components may also be joined by welding or adhesive or the like, which is not limited herein.

Referring to FIG. 3 and FIGS. 7 to 9, in some embodiments, since one positioning platform 221 farthest away from the body 10 can be covered by the exposed insulating tape 230 after the positioning member 21 is inserted into the hole 240 of the winding core 200, the length of the positioning platform 221 farthest away from the body 10 in the axial direction of the body 10 is larger than the length of the remaining positioning platform 221 in the axial direction of the body 10. That is, the length of one positioning platform 221 provided close to the winding core 200 is the longest, and the positioning platform 221 is not generally used as a length judgment of the insulating tape 230. Therefore, the length of the positioning platform 221 is the longest, and the structural strength of the positioning member 21 can be increased.

It should be understood that, as the first positioning member 21 is inserted into the hole 240, the first positioning platform 221 abuts against the end surface 250 of the winding core 200 away from the end surface of the body 10. In this case, the measurement device 100 stops insertion of the first positioning member 21. That is, the exposed length of the insulating tape 230 can be roughly judged.

Referring to FIGS. 4 to 6 and FIGS. 8 to 10, which show a schematic structural diagram of a second measurement structure b in some embodiments of the present disclosure. In order to accurately measure the length of the exposed portion of the insulating tape 230, the second length measuring member is provided on an outer wall of the body 10, and the body 10 can be inserted into an enclosed space of the insulating tape 200. The second length measuring member is provided with a scale 222. That is, when the second measurement structure measures the length of the insulating tape 230, as the second positioning member 21 is inserted into the hole 240, the body 10 is also inserted into the enclosed space of the insulating tape 230, and the end portion of the body 10 abuts against the end surface 250 of the winding core 200. In this case, the length of the insulating tape 230 can be obtained from the reading of the scale 222 on the body 10, so that the accuracy of the length of the insulating tape 230 can be judged more accurately. For example, when the type of the battery is replaced by the production line, the exposed length of the insulating tape 230 is changed greatly. In this case, the scale 222 is used for accurate measurement, so that the accuracy of the judged length is improved. After the first accurate measurement is completed, the first measurement structure a can be used for rapid measurement.

It should be understood that, when the measurement structure is used for measurement, an outer diameter of the body 10 is smaller than an inner diameter of the insulating tape 230, so that the body 10 can be inserted into the space formed around the insulating tape 230.

In some embodiments, in order to enable the first positioning member 21 or the second positioning member 21 to be quickly inserted into the hole 240, the end portion 211 of the first positioning member 21 away from the body 10 and/or the end portion 211 of the second positioning member 21 is a tip. As such, the end portion of the first positioning member 21 or the second positioning member away from the body 10 is provided as a tip, which has a guiding function and can be quickly inserted into the winding core 200 in alignment, thereby improving the measurement efficiency.

It should be understood that the end portion 211 of the first positioning member may be provided as a tip, or the end portion 211 of the second positioning member may be provided as a tip, or both the end portion 211 of the first positioning member and the end portion 211 of the second positioning member may be provided as a tip.

In some embodiments, the shape of the tip may be provided in a conical shape, a spherical shape, an elliptical shape, etc., all of which may achieve a guiding effect.

In some embodiments, when a preparation material of the measurement device 100 is selected, since a foil material of the winding core 200 includes copper, aluminum, and is coated with a material such as lithium iron phosphate, materials of the measurement structure 20 and the body 10 should avoid using materials such as copper, aluminum, and lithium iron. As such, the body 10 and the two measurement structures 20 can be made of ceramic or stainless steel material having a coating on the surface thereof, and contact with the material of the winding core 200 is avoided.

The measurement device 100 can insert the first positioning member or the second positioning member into the hole 240 of the winding core 200 by means of the hand, and quickly and roughly obtain the length of the insulating tape 230 by means of the positioning platform 221 in the first measurement structure a. Alternatively, the read length value is accurately read by the scale 222 in the second measurement structure b. As such, the above two methods can achieve following effects.
(1) The length of the insulating tape 230 can be quickly judged on the production line, so that the winding core 200 does not need to be removed from the production line for a long time, and the shutdown is not required, thereby ensuring the production capacity and the production efficiency.
(2) A case where the CCD may make a misjudgement when the color of the insulating tape 230 and the color of the tail glue of the winding core 200 are similar to each other.
(3) The result of the length can be obtained in time, and there is the characteristic of high test efficiency.
(4) The result can be quickly obtained by either the first measurement structure a or the second measurement structure b, which is straightforward and does not require unit conversion.
(5) The measurement device 100 of the present embodiment is relatively simple in structure and low in manufacturing cost.
(6) An on-site worker is able to complete the measurement without a test personnel having a high degree of professionalism, which reduce a company's employment cost.
(7) Since the winding core 200 does not need to be moved away from the production line in a centralized manner, the occurrence of collision damage of the winding core 200 after being moved away from the production line is avoided.

Referring to FIG. 2, in some embodiments, the present disclosure also provides a method 300 for measuring an exposed length of an insulating tape 230, where the method is used to measure an exposed length of the insulating tape 230 with respect to a winding core 200 and includes following steps S31-S33.

At the step S31, the body 10 is held.

For example, the body 10 is held by a hand or a manipulator to enable the measurement device 100 to be subsequently moved along with the body 10.

In some embodiments, the body 10 is held by a worker's hand to enable accurate alignment by the worker's eye.

At the step S32, the positioning member 21 is inserted into the central hole 240 of the winding core 200.

After holding the body 10 in the previous step, the positioning member 21 is inserted into the central hole 240 of the winding core 200 in the present step. A first positioning member or a second positioning member is selectively inserted into the winding core 200 according to an accurate judgment or a rough judgment of the length data.

At the step S33, an exposed length of the insulating tape 230 with respect to the winding core 200 is judged by the length measuring member 22.

When the first positioning member or the second positioning member is inserted into the winding core 200, it is necessary to ensure that the first positioning member or the second positioning member coincides with a central axis of the winding core 200, and the exposed length of the insulating tape 230 is roughly or accurately judged by the positioning platform 221 in the first measurement structure a or the scale 222 in the second measurement structure b.

In some embodiments, if it is determined that the exposed length of the insulating tape 230 does not meet a standard, an attachment position of the insulating tape 230 needs to be adjusted, and the measurement step is performed again after the adjustment. If the measurement result is satisfactory, the winding core 200 is returned to the production line for further production.

What is claimed is:

1. A measurement device for measuring a length of an insulating tape exposed at an end portion of a winding core, comprising:
a body and at least one measurement structure provided on the body, wherein the measurement structure comprises a positioning member inserted into a central hole of the winding core and a length measuring member for measuring an exposed length of the insulating tape with respect to the winding core.

2. The measurement device of claim 1, wherein the measurement device comprises two measurement structures respectively defined as a first measurement structure and a second measurement structure, the first measurement structure and the second measurement structure are provided at both ends of the body, respectively, along a length direction of the body, a first length measuring member in the first measurement structure is configured to perform a rough measurement of the exposed length of the insulating tape with respect to the winding core, and a second length measuring member in the second measurement structure is configured to perform a fine measurement of the exposed length of the insulating tape with respect to the winding core.

3. The measurement device of claim 2, wherein the first length measuring member is provided on a first positioning member of the first measurement structure and comprises a plurality of positioning platforms joined in sequence in an axial direction of the body, the plurality of positioning platforms having different widths in a radial direction of the body, respectively.

4. The measurement device of claim 3, wherein the widths of the plurality of positioning platforms in the radial direction of the body are gradually increased towards a direction close to the body.

5. The measurement device of claim 3, wherein a surface of each of the positioning platforms is coated with a coating, and a color of the coating on the surface of the each of the positioning platforms is different from each other.

6. The measurement device of claim 4, wherein a surface of each of the positioning platforms is coated with a coating, and a color of the coating on the surface of the each of the positioning platforms is different from each other.

7. The measurement device of claim 3, wherein the each of the positioning platforms is cylindrical.

8. The measurement device of claim 4, wherein the each of the positioning platforms is cylindrical.

9. The measurement device of claim 3, wherein a length of one of the positioning platforms away from the body in the axial direction of the body is greater than lengths of remaining positioning platforms in the axial direction of the body.

10. The measurement device of claim 4, wherein a length of one of the positioning platforms away from the body in the axial direction of the body is greater than lengths of remaining positioning platforms in the axial direction of the body.

11. The measurement device of claim 3, wherein the second length measuring member is provided on an outer wall of the body, the body is capable of being inserted into an enclosed space of the insulating tape, and the second length measuring member is provided with a scale.

12. The measurement device of claim 4, wherein the second length measuring member is provided on an outer wall of the body, the body is capable of being inserted into an enclosed space of the insulating tape, and the second length measuring member is provided with a scale.

13. The measurement device of claim 2, wherein at least one of an end portion of the first positioning member of the first measurement structure and an end portion of the second positioning member of the second measurement structure is a tip.

14. The measurement device of claim 3, wherein at least one of an end portion of the first positioning member of the first measurement structure and an end portion of the second positioning member of the second measurement structure is a tip.

15. The measurement device of claim 4, wherein at least one of an end portion of the first positioning member of the first measurement structure and an end portion of the second positioning member of the second measurement structure is a tip.

16. The measurement device of claim 1, wherein the measurement structure and the body are integrally arranged.

17. The measurement device of claim 2, wherein the measurement structure and the body are integrally arranged.

18. The measurement device of claim 3, wherein the measurement structure and the body are integrally arranged.

19. The measurement device of claim 4, wherein the measurement structure and the body are integrally arranged.

20. A method for measuring an exposed length of an insulating tape with respect to a winding core, wherein the method is implemented by the measurement device of claim 1 and comprises:
holding the body;
inserting the positioning member into the central hole of the winding core; and
measuring the exposed length of the insulating tape with respect to the winding core by the length measuring member.
